(19) United States
(12) Patent Application Publication
(10) Pub. No.: US 2012/0105810 A1
(43) Pub. Date: May 3, 2012

(54) PROJECTION DEVICE WITH BRIGHTNESS ADJUSTMENT FUNCTION AND METHOD THEREOF

(75) Inventors: YING-CHUAN YU, Tu-Cheng (TW); YING-XIONG HUANG, Tu-Cheng (TW); HSING-CHU WU, Tu-Cheng (TW)

(73) Assignee: HON HAI PRECISION INDUSTRY CO., LTD., Tu-Cheng (TW)

(21) Appl. No.: 12/980,311

(22) Filed: Dec. 28, 2010

(30) Foreign Application Priority Data
Oct. 27, 2010 (TW) 99136754

(51) Int. Cl. G03B 21/28; G03B 21/14

(52) U.S. Cl. 353/31; 353/85; 353/121

(57) ABSTRACT

A projection device with a brightness adjustment function includes a display, a light source, a lens module, a power supply unit, a light detection unit and a power controller. The light source emits light to the display. The lens module projects the images to be displayed by the display. The power supply unit supplies power for the light source. The light detection unit acquires a digital value of a portion of the light from the light source that is not received by the display, and compares the digital value with a predetermined digital value to generate a control signal. The power controller adjusts power from the power supply unit to the light source according the control signal until the digital value matches the predetermined digital value of the light from the light source.

### RELATED APPLICATIONS

The subject matter disclosed in this application is related to subject matters disclosed in copending applications entitled, “PROJECTION DEVICE WITH BRIGHTNESS ADJUSTMENT FUNCTION AND METHOD THEREOF”, filed **** (Atty. Docket No. US36615); “PROJECTION DEVICE WITH BRIGHTNESS ADJUSTMENT FUNCTION AND METHOD THEREOF”, filed **** (Atty. Docket No. US36614); “PROJECTION DEVICE WITH BRIGHTNESS ADJUSTMENT FUNCTION AND METHOD THEREOF”, filed **** (Atty. Docket No. US36739), and assigned to the same assignee as named herein.

### BACKGROUND

1. Technical Field

The present disclosure relates to projection devices and, particularly, to a projection device having a brightness adjustment function and a method for same.

2. Description of Related Art

In general, projection devices such as projectors are usually connected to an image output device, such as a video tape recorder or a VCD player. When the projection device projects images onto a projection surface in a room that is not dark enough, the images may look washed out.

### BRIEF DESCRIPTION OF THE DRAWINGS

FIG. 1 is a block diagram of a hardware infrastructure of a projection device with a brightness adjustment function in accordance with an exemplary embodiment.

FIG. 2 is a schematic diagram showing an optical principle of the projection device of FIG. 1.

FIG. 3 is a block diagram of a hardware infrastructure of a projection device with a brightness adjustment function in accordance with another embodiment.

FIG. 4 is a schematic diagram showing an optical principle of the projection device of FIG. 3.

FIG. 5 is a flowchart of a method having a brightness adjustment function implemented by the projection device of FIG. 1, in accordance with an exemplary embodiment.

### DETAILED DESCRIPTION

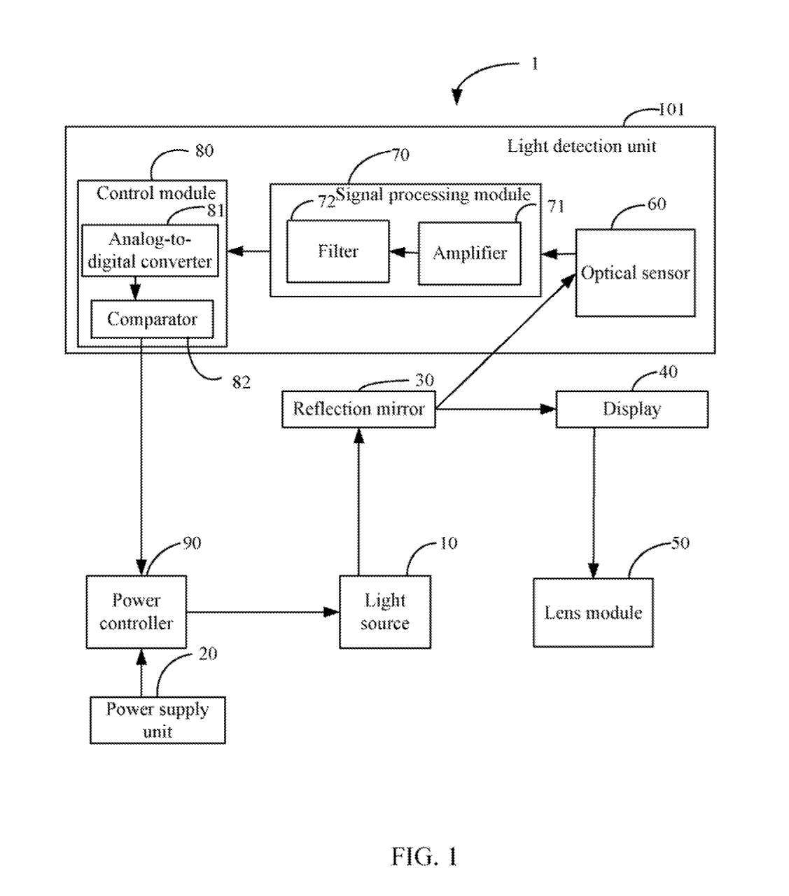

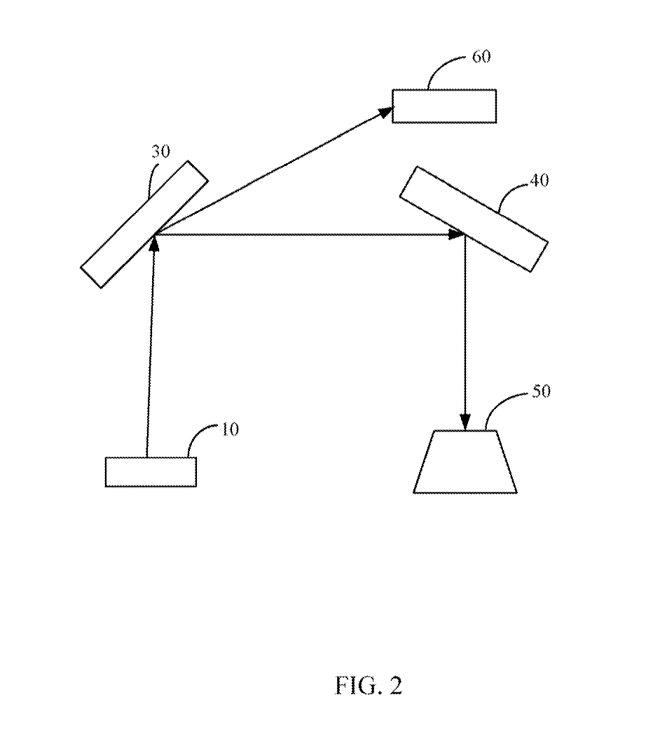

Referring to FIGS. 1-2, a projection device 1 includes a light source 10, a power supply unit 20, a power controller 90, a reflection mirror 30, a display 40, a light detection unit 101 and a lens module 50.

The light source 10 emits light to the reflection mirror 30. In one embodiment, the light source 10 may be an LED, or a RGB LED.

The power supply unit 20 supplies power to the light source 10 through the power controller 90, thereby controlling a digital value of the light from the light source 10.

The reflection mirror 30 reflects the light from the light source 10 to the display 40. The display 40 receives the light from the reflection mirror 30 and displays images. The lens module 50 projects the images being displayed by the display 40 onto a projection surface. During the reflection of the light on the display 40, due to the fact that a covering area of the light reflected by the reflection mirror 30 is greater than the area of the display 40, a portion of the light reflected by the reflection mirror 30 will not be received by the display 40. In other embodiments, the light source 10 can directly emit light to the display 40.

The light detection unit 101 acquires a digital value of the portion of the light which is not received by the display 40, and compares the digital value with a predetermined digital value to generate a control signal. In one embodiment, the light detection unit 101 includes an optical sensor 60, a signal processing module 70, and a control module 80. The optical sensor 60 senses the portion of the light, which is not received by the display 40 to generate a sensing signal. In one embodiment, the optical sensor 60 is a micro-electro mechanical system (MEMS) sensor.

The signal processing module 70 includes an amplifier 71 and a filter 72. The amplifier 71 amplifies the sensing signal from the optical sensor 60. The filter 72 filters the amplified sensing signal to generate an analog signal.

The control module 80 includes an analog-to-digital converter 81 and a comparator 82. The analog-to-digital converter 81 converters the analog signal to a digital signal. The comparator 82 compares the converted digital signal with a predetermined digital signal to generate the control signal.

The power controller 90 adjusts power from the power supply unit 20 to the light source 10 according to the control signal until the digital value matches the predetermined digital value of light from the light source 10.

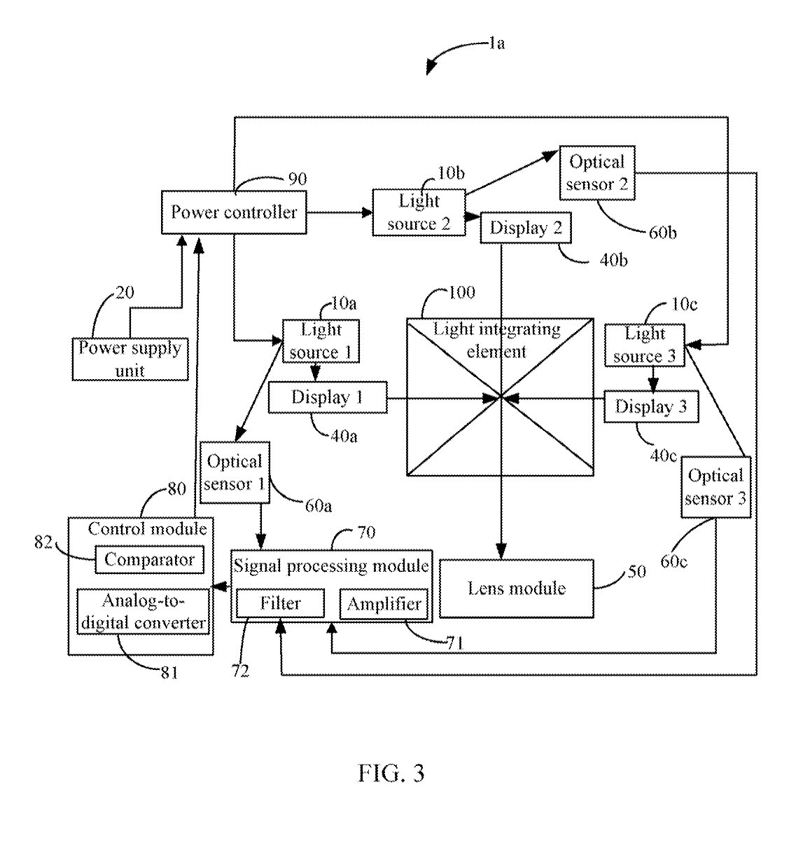

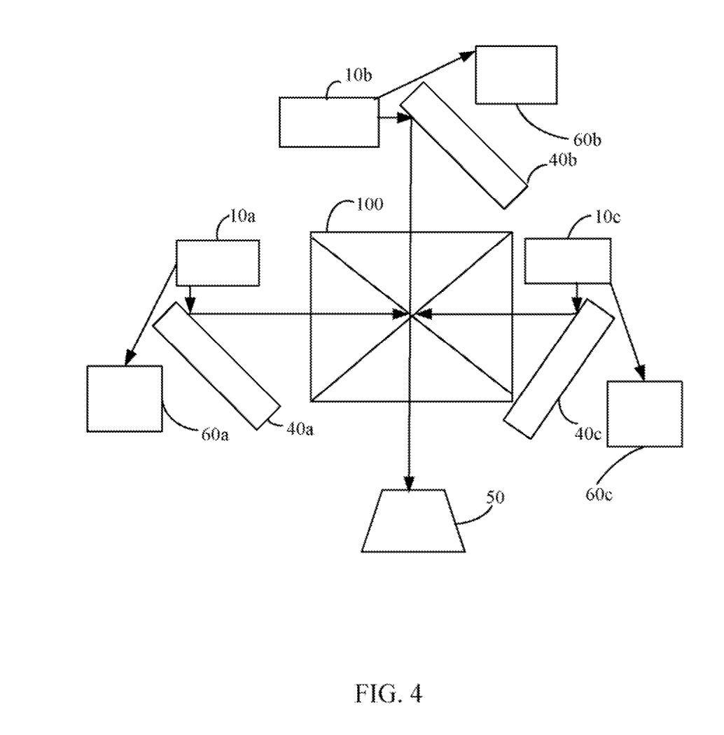

As shown in FIGS. 3-4, in another embodiment of the disclosure, the projection device 1a includes three light sources 10a, 10b and 10c, three displays 40a, 40b and 40c, and a light integrating element 100. The three displays 40a, 40b, and 40c respectively display the same images. In one embodiment, the three light sources 10a, 10b, and 10c are red light, green light, and blue light source, and respectively emit the light to the three displays 40a, 40b, and 40c. The light integrating element 100 is for integrating the images from the displays 40a, 40b, and 40c to the lens module 50.

The light detection unit 101 includes three optical sensors 60a, 60b, and 60c which respectively sense the light from the light sources 10a, 10b, and 10c, which is not received by the three displays 40a, 40b and 40c to generate three sensing signals.

The signal processing module 70 amplifies and filters the three sensing signals to generate three corresponding analog signals. The control module 80 converts the three analog signals to three digital signals, and respectively compares the three digital signals with the predetermined digital signal to generate three control signals. The power controller 90 adjusts power from the power supply unit 20 to the three light sources 10a, 10b, and 10c according to the three control signals until the digital value respectively matches the predetermined digital value of the light from the three light sources 10a, 10b, and 10c.

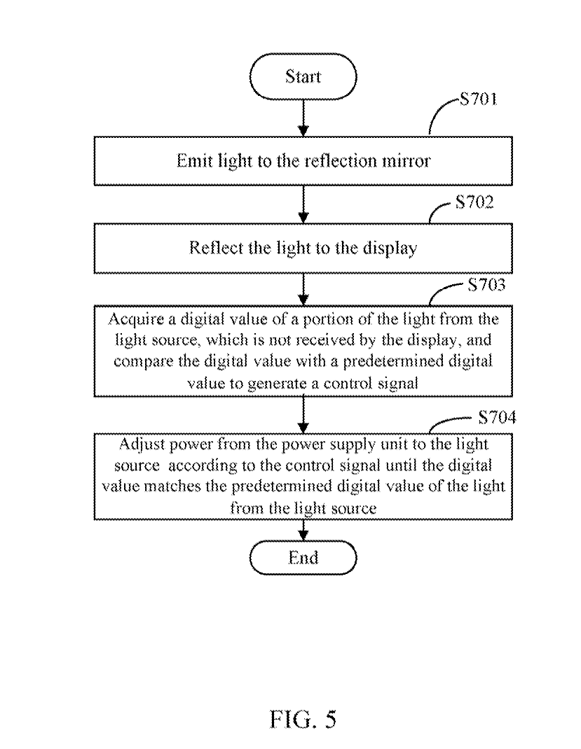

FIG. 5 is a flowchart of a method having a brightness adjustment function implemented by the projection device of FIG. 1, in accordance with an exemplary embodiment.

In step S701, the light source 10 emits the light to the reflection mirror 30.

In step S702, the reflection mirror 30 reflects the light from the light source 10 to the display 40.

In step S703, the light detection unit 101 acquires a digital value of a portion of the light that is not received by the display 40, and compares the digital value with the predetermined digital value to generate the control signal.

In step S704, the power controller 90 adjusts power from the power supply unit 20 to the light source 10 according to the control signal until the digital value matches the predetermined digital value of light from the light source 10.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A projection device with a brightness adjustment function, comprising:
a display;
a light source for emitting light to the display;
a lens module for projecting the images to be displayed by the display;
a power supply unit for supplying power for the light source;
a light detection unit for acquiring a digital value of a portion of the light from the light source that is not received by the display, and comparing the digital value with a predetermined digital value to generate a control signal; and
a power controller for adjusting power from the power supply unit to the light source according to the control signal until the digital value matches the predetermined digital value of the light from the light source.

2. The projection device as described in claim 1, further comprising:
a reflection mirror for reflecting the light from the light source to the display.

3. The projection device as described in claim 1, wherein the light source is an LED or a RGB LED.

4. A projection device with a brightness adjustment function comprising:
three displays for displaying a same images;
three light sources for respectively emitting light to the three displays;
a lens module for projecting the images to be displayed on the three displays;
a power supply unit for supplying power for the three light sources;
a light detection unit for respectively acquiring a digital value of a portion of the light from each of the three light sources that is not received by the corresponding display, and comparing the digital value with a predetermined digital value to generate one of three control signals; and
a power controller for adjusting power from the power supply unit to the three light sources according to the three control signals until the three digital values respectively matches the predetermined digital value of the light from the three light sources.

5. The projection device as described in claim 4, wherein the three light sources are red light, green light and blue light source.

6. The projection device as described in claim 4, further comprising:
a light integrating element which is used for integrating the images from the three displays to the lens module.

7. A method with a brightness adjustment function implemented by a projection device; wherein the projection device comprises a light source, a power supply unit, and display, the method comprising:
emitting light to the display;
acquiring a digital value of a portion of the light from the light source that is not received by the display, and comparing the digital value with a predetermined digital value to generate a control signal; and
adjusting power from the power supply unit to the light source according the control signal until the digital value matches the predetermined digital value of the light from the light source.
